(19) United States
(12) Patent Application Publication
(10) Pub. No.: US 2008/0202604 A1
(43) Pub. Date: Aug. 28, 2008

(54) Apparatus to regulate fluid flow

(76) Inventor: James Matthew Dalton, Elk River, MN (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/711,962

(22) Filed: Feb. 28, 2007

(51) Int. Cl. G05D 16/04; F16K 15/00

(52) U.S. Cl. 137/505.35

(57) ABSTRACT

Apparatus to regulate fluid flow is disclosed. The apparatus includes a valve member deformable to distribute forces to a valve seat and prevent damage to the valve member.

### FIELD OF THE DISCLOSURE

This disclosure relates generally to fluid flow regulators and, more particularly, to apparatus to regulate high pressure fluid flow which includes a valve member deformable to distribute forces to a valve seat.

### BACKGROUND

Industrial processing plants use regulator valves in a wide variety of applications such as, for example, controlling the flow of a gas or fluid in a processing operation. The regulation of the flow of gas requires that a regulator valve accommodate a high flow rate of gas at high pressures and maintain the purity of the gas. Thus, a manufacturer of such regulator valves may certify that the valves are free from contamination by particles created or left behind during the manufacture of the valves. However, despite rigorous manufacturing processes to ensure the absence of particle contamination such as, for example, metal filings, regulator valves may experience contamination in the form of particles introduced into the regulator valve during or after manufacture. The presence of contaminants may result in damage to parts of a main orifice (e.g., a seat) of the regulator valve and cause a significant leak to occur.

### SUMMARY

An apparatus to regulate fluid flow comprises a housing having an inlet and an outlet, a valve seat at a valve passage wherein the valve seat defines a first diameter surface extending to a larger diameter second surface, and a valve member is movable to engage the valve seat. The valve member has a deformable member to engage the first diameter surface of the valve seat and deformable to engage the second surface.

### BRIEF DESCRIPTION OF THE DRAWINGS

FIG. 1 is a cut-away illustration of an example fluid flow regulator valve.

FIG. 2 is an enlarged view of the circled portion of FIG. 1.

### DETAILED DESCRIPTION

In general, the example apparatus described herein may be utilized for regulating fluid flow in various types of fluid flow processes. Additionally, while the examples described herein are described in connection with the control of product flow for the industrial processing industry, the examples described herein may be more generally applicable to a variety of process control operations for different purposes.

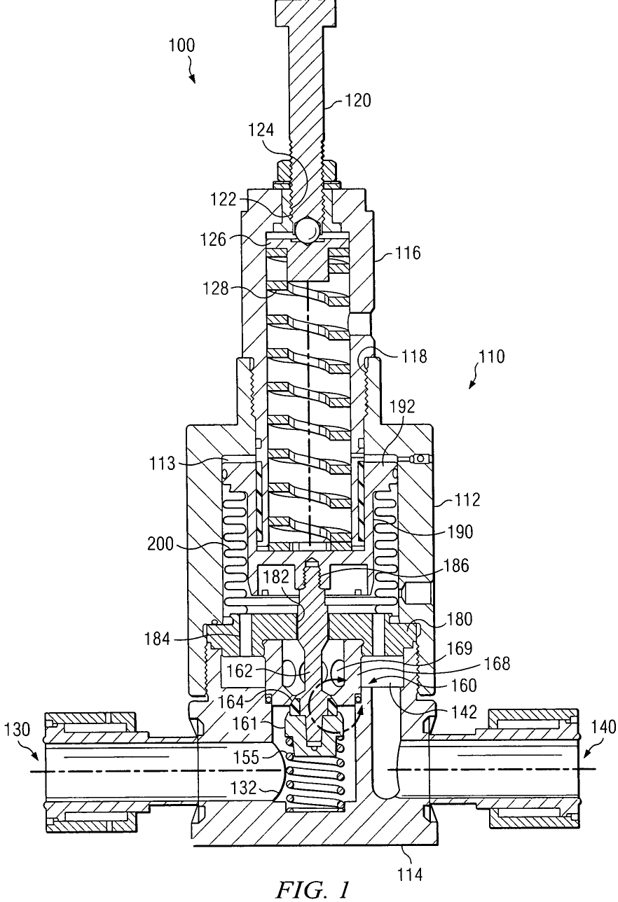

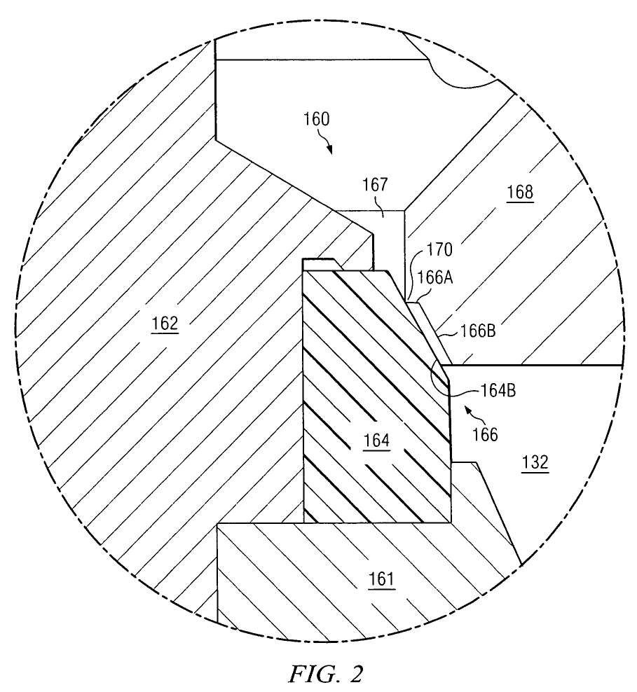

FIG. 1 is a cut-away illustration of an example fluid flow regulator valve 100. The example fluid flow regulator valve 100 includes a body or housing 110 having an upper housing 112 defining a chamber 113, a lower housing 114 defining an inlet chamber 132, and an adjustment housing 116 received by the upper housing 112 at threaded connection 118. An adjustment screw 120 has a threaded end 122 received at threads 124 of the adjustment housing 116. The adjustment screw 120 engages an end member 126 which abuts a resilient member or load spring 128 located within the adjustment housing 116 and the upper housing 112. The lower housing 114 includes an inlet 130 and an outlet 140. The inlet 130 communicates with the inlet chamber 132 in which is located a valve spring 155. A main valve is designated generally by reference numeral 160. The valve spring 155 engages a lower end 161 of a valve stem 162 to urge the valve stem 162 toward the upper housing 112. The valve stem 160 has a deformable valve member 164. As shown most clearly in FIG. 2, the deformable valve member 164 has a generally flat angled surface 164B that engages a valve seat 166 of an orifice or passage 167 disposed at a stem cap 168. As can be readily seen in FIG. 1, the stem cap 168 includes lateral openings 169 to permit fluid flow to a passage 142 communicating with the outlet 140.

Referring to FIG. 1, a valve guide 180 is located between the upper housing 112 and the lower housing 114. The valve guide 180 has a central opening 182 receiving the valve stem 162, and radially outer through openings 184 for fluid flow therethrough. The valve stem 162 extends upwardly to engage threadingly, at threads 186, a movable sensor 190. The movable sensor 190 is located within the chamber 113 of the upper housing 112. A diaphragm 200 extends between a sensor flange 192 and the valve guide 180.

The load spring 128 is received within the sensor 190 to urge the sensor 190 and the valve stem 162 downwardly toward the lower housing 114. The adjustment screw 120 may be rotated to adjust the force of the load spring 128 upon the sensor 190 and the valve stem 162.

FIG. 2 is an enlarged view of a portion of the main valve 160 circled in FIG. 1. The deformable valve member 164 is a unitary member mounted upon the valve stem 162. The deformable valve member 164 may be made of numerous nonmetal materials such as, for example, polychlorotrifluoroethylene or PCTFE (Neoflon™) or polytetrafluoroethylene (Teflon®), which may deform substantially when engaging the valve seat 166. The deformable valve member 164 engages the valve seat 166 to close the passage 167 and prevent fluid flow therethrough. The valve seat 166 includes a first diameter surface 166A that has a corner 170 and extends radially outwardly to a larger diameter second surface 166B. As illustrated in FIG. 2, the larger diameter second surface 166B is a flat angled surface offset from the first diameter surface 166A and disposed parallel to the flat angled surface 164B of the deformable valve member 164. Alternatively, the larger diameter second surface 166B can be configured in other shapes such as, for example, one or more surfaces or corners similar to the first diameter surface 166A but offset from the first diameter surface 166A, one or more undulations offset from the first diameter surface 166A, or other shapes which are offset from the first diameter surface 166A.

In operation, the example fluid flow regulator valve 100 receives high pressure fluid or gas such as, for example, hydrogen chloride, at the inlet 130. Initially, the fluid flow regulator valve 100 is closed because the adjuster screw 120 is retracted upwardly such that the load spring 128 permits the valve spring 155 to displace the valve stem 162 upwardly. The deformable valve member 164 engages the valve seat 166 (see FIG. 2) to close the main valve 160. When the adjustment screw 120 is rotated and advanced downwardly, the load spring 128 exerts a downward force on the sensor 190 and the valve stem 162 to displace the deformable valve member 164 away from the valve seat 166 and permit gas to flow through the passage 167 of the main valve 160. When the passage 167 is open, gas flowing into the inlet chamber 132 passes through the passage 167, to the stem cap 168, and through the lateral openings 169 and the passage 142 to the outlet 140.

The example fluid flow regulator valve 100 accomplishes the regulated flow of a fluid or gas at a desired pressure. If a greater than desired pressure of gas flows through the main valve 160, the downstream pressure of the gas (e.g., at the outlet 140) will increase and produce an increase in the gas pressure exerted upon the sensor 190. The increased gas pressure causes the sensor 190 and the attached valve stem 162 to move upwardly so that the deformable valve member 164 moves into engagement with the valve seat 166 and closes the main valve 160. More particularly, the sensor 190 and the attached valve stem 162 are urged upwardly by the increased pressure and cause the deformable valve member 164 to engage the first diameter surface 166A of the valve seat 166 (see FIG. 2). The engagement of the deformable valve member 164 with the first diameter surface 166A closes the passage 167.

However, in the event that particles such as, for example, metal filings, are introduced into the example fluid flow regulator valve 100 during or after manufacture of the valve 100, such particles may prevent the full closure of the passage 167. The presence of contaminants such as, for example, metal filings can result in the gas continuing to flow through the passage 167 and result in a continued increase in the downstream gas pressure. The continued increase in the downstream gas pressure results in increased the gas pressure against the sensor 190. As the sensor 190 is forced upwardly by the increased gas pressure, the valve member 164 engages the first diameter surface 166A with force greater than that which normally occurs during the operation of the example fluid flow regulator valve 100. The valve seat 166 can accommodate such greater engagement force of the deformable valve member 164 with the first diameter surface 166A. As the deformable valve member 164 moves upwardly against the first diameter surface 166A, the deformable member 164 deforms to receive therein the first diameter surface 166A until the flat angled surface 164B engages simultaneously the larger diameter second surface 166B. The flat angled surface 164B and the larger diameter second surface 166B are generally parallel to one another and, thus, their engagement results in a substantially uniform distribution of the forces exerted by the flat angled surface 164B upon the larger diameter second surface 166B. The substantially uniform distribution of the forces prevents the deformable valve member 164 from being damaged such that the valve member 164 could not close the passage 167. If the valve member 164 was damaged to the extent that the gas were to continue to flow through the passage 167, the example fluid flow regulator valve 100 could produce significant shifts of downstream pressure in the gas flow. Thus, the simultaneous engagement of the flat angled surface 164B with the first diameter surface 166A and the larger diameter second surface 166B prevents damage to the valve member 164 and the resulting undesirable flow of fluid or gas through the example fluid flow regulator valve 100.

If other conditions were to exist that could result in damage to the main valve 160 of the example regulator valve 100, such as, for example, the fluid pressure communicated to the inlet 130 being greater than that which is normally received by the example fluid flow regulator valve 100, or the main valve 160 being subjected to excessive cycling, the deformable valve member 164 can deform as described above to prevent such damage.

Although certain example apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. Apparatus to regulate fluid flow, comprising:
a housing having an inlet and an outlet;
a valve seat at a valve passage, the valve seat defining a first diameter surface that extends to a larger diameter second surface; and
a valve member movable to engage the valve seat, the valve member having a deformable member to engage the first diameter surface of the valve seat and deformable at the first diameter surface to engage the second surface.

2. Apparatus as defined in claim 1, wherein the first diameter surface is configured to include a corner and the second surface is configured as a flat surface offset from the first diameter surface.

3. Apparatus as defined in claim 1, wherein the second surface is a flat surface offset from the first diameter surface.

4. Apparatus as defined in claim 3, wherein the deformable member has a surface substantially parallel to the second surface.

5. Apparatus as defined in claim 1, wherein the engagement of the deformable member with the second surface enables a substantially uniform transfer of forces from the deformable member to the second surface.

6. Apparatus as defined in claim 1, wherein the valve member includes a stem moveable by an adjustable resilient member.

7. Apparatus as defined in claim 1, wherein the apparatus is a pressure regulator valve.

8. Apparatus as defined in claim 7, wherein the pressure regulator valve is an unbalanced regulator valve.

9. Apparatus as defined in claim 1, wherein the deformable member is made of a non-metallic material.

10. Apparatus as defined in claim 1, wherein the valve seat is made of metal.

11. Apparatus as defined in claim 1, wherein the deformable member is a unitary structure mounted to the valve member.

12. A fluid flow regulator valve, comprising:
a housing having an inlet communicating with an outlet via a valve seat at a valve passage, the valve seat defining a first diameter surface that extends to a larger diameter second surface, the second surface configured as a flat surface offset from the first diameter surface; and
a valve member movable to engage the valve seat, the valve member including a stem coupled operatively to a resilient member and a deformable member to engage the first diameter surface of the valve seat and deformable at the first diameter surface to engage simultaneously the second surface.

13. The fluid flow regulator valve as defined in claim 12, wherein the engagement of the deformable member with the flat surface enables a substantially uniform transfer of forces from the deformable member to the flat surface.

14. The fluid flow regulator valve as defined in claim 13, wherein the first diameter surface is configured to include a corner and the second surface is offset from the first diameter surface.

15. The fluid flow regulator valve as defined in claim 12, wherein the deformable member has a surface substantially parallel to the second surface.

16. The fluid flow regulator valve as defined in claim 12, wherein the resilient member is adjustable to vary a force upon the stem.

17. The fluid flow regulator valve as defined in claim 12, wherein the fluid flow regulator valve is an unbalanced regulator valve.

18. The fluid flow regulator valve as defined in claim 12, wherein the deformable member is made of a non-metallic material.

19. The fluid flow regulator valve as defined in claim 18, wherein the valve seat is made of metal.

20. The fluid flow regulator valve as defined in claim 12, wherein the deformable member is a unitary structure mounted to the valve member.
